(19) United States
(12) Patent Application Publication
(10) Pub. No.: US 2009/0057120 A1
(43) Pub. Date: Mar. 5, 2009

(54) SWITCH DEVICE

(75) Inventors: Hideyo Kakuno, Tajimi-shi (JP); Katsuya Koyama, Aisai-shi (JP); Takuya Eguchi, Nagoya-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/202,608

(22) Filed: Sep. 2, 2008

(30) Foreign Application Priority Data
Sep. 3, 2007 (JP) 2007-227273

(51) Int. Cl. H01H 13/00

(52) U.S. Cl. 200/339

(57) ABSTRACT

There is provided a switch device including a tubular portion which is provided in a casing and is opened at its upper and lower surfaces; a supporting shaft provided in the tubular portion; a manipulation knob which is mounted to the tubular portion such that it covers the opening in the upper surface and is operated to be rotated about the supporting shaft by being manipulated; a switch provided in the casing; a manipulation bar for transmitting the rotating operation on the manipulation knob for changing over the switch between an ON state and an OFF state; an elastic member which generates an elastic force for restoring, to a predetermined rest position, the manipulation knob which has been operated to be rotated; and a first impingement portion and a first to-be-impinged portion which are provided in the manipulation knob and in the tubular portion and are impinged on each other if the manipulation knob is operated to be rotated to reach a limit of this operation, wherein a second impingement portion and a second to-be-impinged portion are provided in surfaces of the manipulation knob and the tubular portion which are different from the surfaces provided with the first impingement portion and the first to-be-impinged portion.

### BACKGROUND OF THE INVENTION

1. Technical Field

The present invention relates to a switch device for changing over switches between ON and OFF states if manipulation knobs are operated.

2. Related Art

In a switch device for changing over switches between ON and OFF states if manipulation knobs are operated, sounds may occur if members in the switch device impinge on each other when the manipulation knobs are operated. Such sounds of impingements are uncomfortable for users and become noises

Therefore, Japanese Unexamined Utility Model Publication No. 05-36721 discloses a switch device structured to include a buffer member interposed between the inner bottom surface of a tubular-shaped protruding portion and the lower end surface of a sliding member which impinge on each other when a manipulation knob is manipulated, in order to reduce the sounds of impingements during manipulations. Further, Japanese Unexamined Utility Model Publication No. 02-87339 discloses a switch device structured to include a flexible portion formed through co-molding from a thermoplastic resin with lower surface hardness such as elastomer on any one of an outer side surface of a manipulation handle and a butting portion formed from the inner surface of a hole in a cover which impinge on each other when the manipulation handle (corresponding to a manipulation knob) is manipulated or structured to include, on the lower end portion of the manipulation handle, a flexible portion for buffering against the impact with a terminal plate or a flat spring for avoiding the impingement between the manipulation handle and the butting portion.

### SUMMARY

As described above, conventional switch devices as in Japanese a Unexamined Utility Model Publication No. 05-36721 and Japanese Unexamined Utility Model Publication No. 02-87339 are structured such that components are impinged on each other at a single concentrated position when a manipulation knob is operated, and a buffer member is interposed at this impingement position. It is an object of the present invention to disperse the impingement position for reducing the sounds of impingements when a switch device is manipulated.

In accordance with one aspect of the present invention, there is provided a switch device including: a tubular portion which is provided in a casing and is opened at its upper and lower surfaces; a supporting shaft provided in the tubular portion; a manipulation knob which is mounted to the tubular portion such that it covers the opening in the upper surface and is operated to be rotated about the supporting shaft by being manipulated; a switch provided in the casing; a manipulation bar for transmitting the rotating operation on the manipulation knob for changing over the switch between an ON state and an OFF state; an elastic member which generates an elastic force for restoring to a predetermined rest position, the manipulation knob which has been operated to be rotated; and a first impingement portion and a first to-be-impinged portion which are provided in the manipulation knob and in the tubular portion and are impinged on each other if the manipulation knob is operated to be rotated to reach a limit of this operation; wherein a second impingement portion and a second to-be-impinged portion are provided in surfaces of the manipulation knob and the tubular portion which are different from the surfaces provided with the first impingement portion and the first to-be-impinged portion. In this case, the switch refers to a component including an electric contact point which operates to be opened or closed.

According to the present invention, it is possible to disperse the position at which the manipulation knob and the tubular portion impinge on each other, thereby reducing the sound of impingement which occurs when the manipulation knob is manipulated.

### BRIEF DESCRIPTION OF THE DRAWINGS

FIG. 1 shows a perspective view of a switch device according to an embodiment of the present invention;

FIG. 2 shows a cross-sectional view of the same switch device;

FIG. 3 shows a perspective view of a casing in the same switch device;

FIG. 4 shows a perspective view of a manipulation knob in the same switch device;

FIG. 5A shows an enlarged side view of the vicinity of a manipulation knob in the same switch device;

FIG. 5B shows an enlarged side view of the vicinity of a manipulation knob in the same switch device;

FIG. 5C shows an enlarged side view of the vicinity of a manipulation knob in the same switch device;

FIG. 6A shows an enlarged cross-sectional view of the vicinity of a manipulation knob in the same switch device;

FIG. 6B shows an enlarged cross-sectional view of the vicinity of a manipulation knob in the same switch device;

FIG. 6C shows an enlarged cross-sectional view of the vicinity of a manipulation knob in the same switch device;

FIG. 7 shows a view illustrating another embodiment; and

FIG. 8 shows a view illustrating still another embodiment.

### DETAILED DESCRIPTION

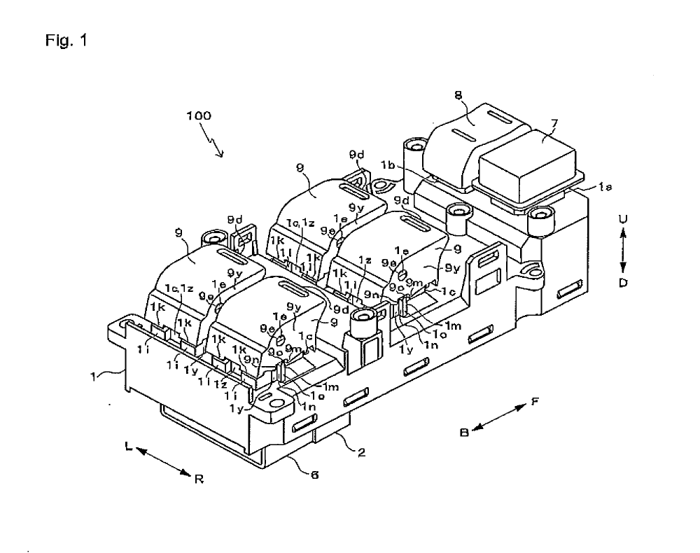

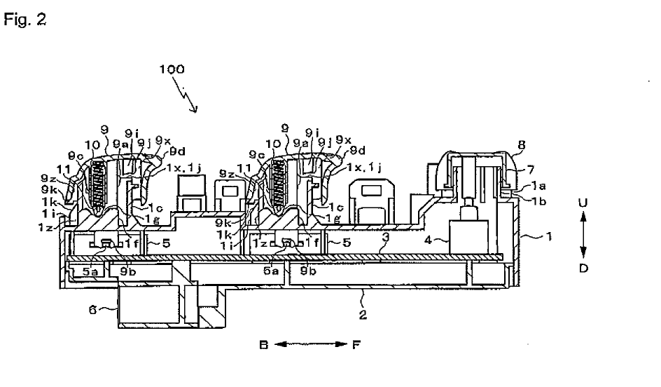

FIG. 1 is a perspective view of a switch device 100 according to an embodiment of the present invention. FIG. 2 is a cross-sectional view of the switch device 100. The switch device 100 is used in a power window device and is mounted in an arm rest (not illustrated) provided on the door at the driving seat in a vehicle. The switch device 100 has a casing 1 which is opened at its lower side (the side in the direction D), and a lid 2 is fitted to the opening so that it is closed, as illustrated in FIG. 2. The casing 1 houses electronic components such as a circuit board 3 and electric switches 4 and 5. The circuit board 3 is sandwiched between the casing 1 and the lid 2 and is supported thereby. On the circuit board 3, electronic components such as the electric switches 4 and 5 and a connector 6 are mounted to form an electric circuit. The connector 6 is protruded from the lid 2. A cable for connecting the connector 6 to a control device which is not illustrated is fitted to the connector 6, which enables transmitting output signals of the electric switches 4 and 5 and the like from the switch device 100 to the control device.

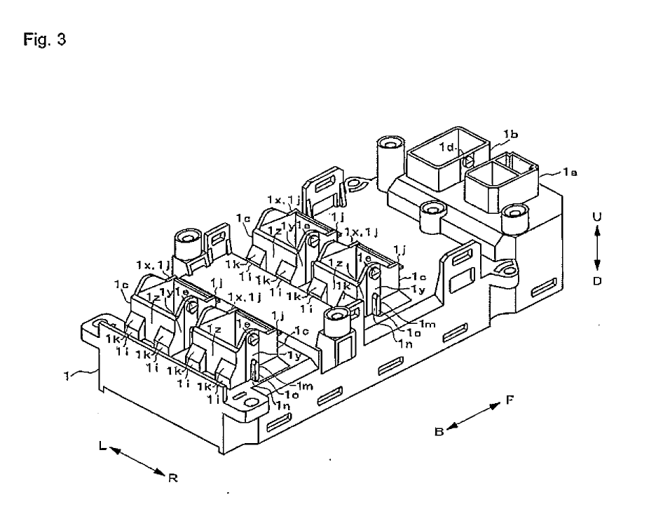

FIG. 3 is a perspective view of the casing 1. On the casing 1, rectangular-shaped tubular portions 1a to 1c are provided integrally therewith. The tubular portions 1a to 1c are opened at their upper surfaces (their end surfaces in the side in the direction U) and their lower surfaces (their end surfaces in the side in the direction D) and are communicated with the inside of the casing 1. A manipulation knob 7 which is illustrated in FIGS. 1 and 2 is mounted to the tubular portion 1a such that it covers the upper surface of the tubular portion 1a. The manipulation knob 7 is engaged with the push-lock type electric switch 4, as illustrated in FIG. 2, at the state where the manipulation knob 7 is mounted to the tubular portion 1a. If the manipulation knob 7 is pushed through manipulation, an electric contact point, not illustrated, which is provided inside the electric switch 4 is changed over to an ON state (close; conduction) or an OFF state (open; non-conduction), thereby locking all the windows of the vehicle for preventing them from being opened and closed or releasing the lock.

On the side surfaces of the tubular portion 1b in the leftward and rightward directions (in the shorter longitudinal direction of the casing 1) L and R, supporting shafts 1d are provided integrally therewith, as illustrated in FIG. 3 (the supporting shaft 1d in the side in the direction L is not illustrated). A manipulation knob 8 illustrated in FIGS. 1 and 2 is mounted to the tubular portion 1b, such that it covers the opening in the upper surface of the tubular portion 1b. The manipulation knob 8 is engaged with an electric switch, not illustrated, which is mounted on the circuit board 3, at a state where the manipulation knob 8 is mounted to the tubular portion 1b. Further, the manipulation knob 8 is operated to be rotated about the supporting shaft 1d, by being swayed through manipulation in the forward and rearward directions (in the longitudinal direction of the casing 1) F and B. If the manipulation knob 8 is operated to be rotated, an electric contact point, not illustrated, which is provided inside the aforementioned electric switch is changed over to an ON state or an OFF state, thereby locking all the windows of the vehicle for preventing them from being opened and closed or releasing the lock.

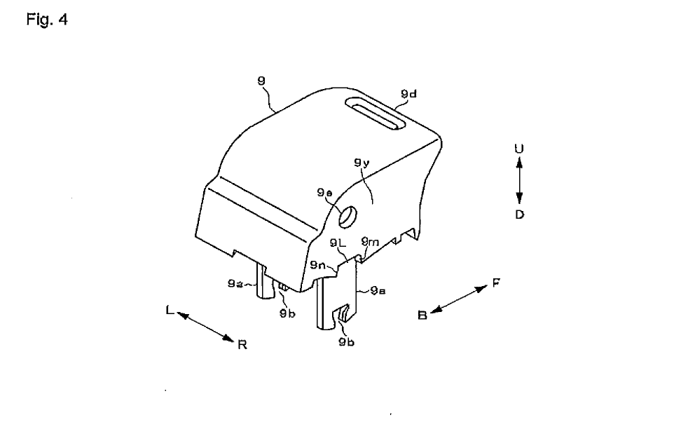

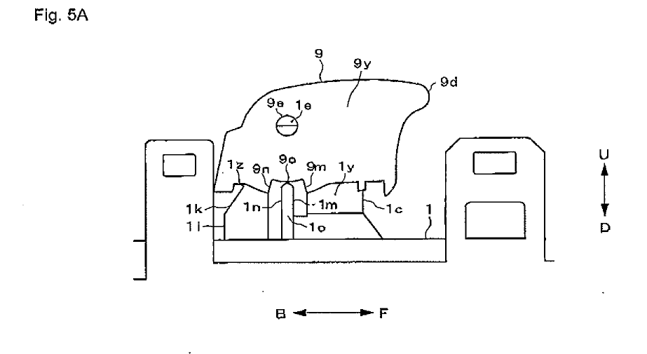

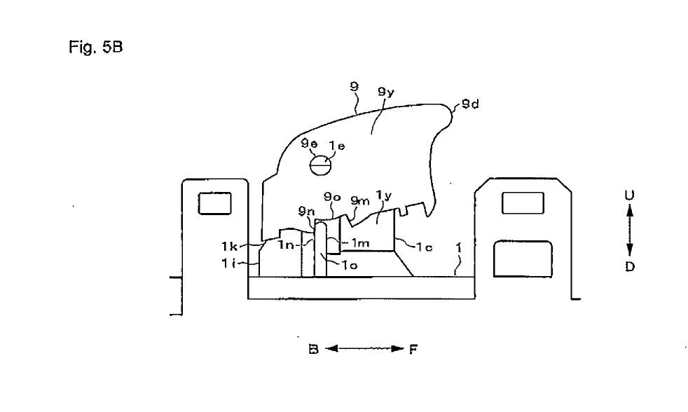

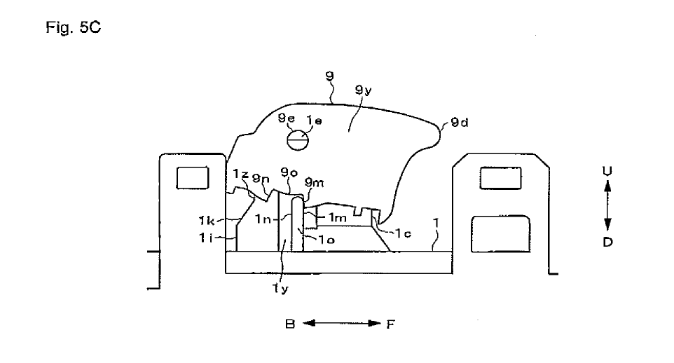

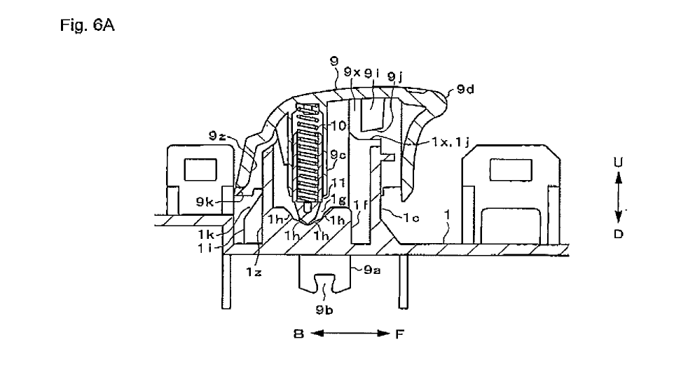

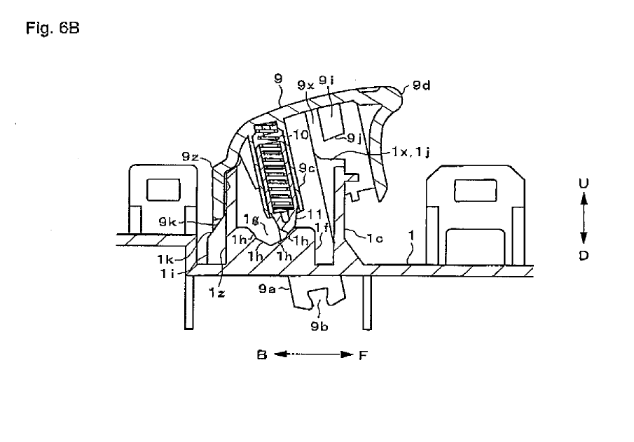

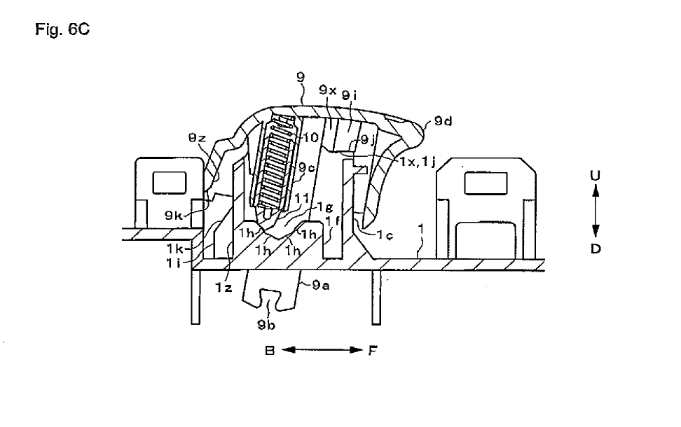

Four tubular portions 1c are provided on the casing 1, as illustrated in FIG. 3. Manipulation knobs 9 illustrated in FIGS. 1 and 2 are mounted to the respective tubular portion 1c such that they cover the openings in the upper surfaces 1x of the respective tubular portions 1c. FIG. 4 is a perspective view of a manipulation knob 9. FIGS. 5A to 5C are enlarged side views illustrating the vicinity of a manipulation knob 9 in the switch device 100. FIGS. 6A to 6C are enlarged cross-sectional views illustrating the vicinity of a manipulation knob 9 in the switch device 100. The casing 1, the lid 2 and the manipulation knobs 7 to 9 are formed through common injection molding from materials made of synthetic resins.

Through the outer side surfaces (the side walls) 9y of the manipulation knobs 9 in the leftward and rightward directions L and R, holes 9e are provided, as illustrated in FIG. 1, FIG. 4 and FIGS. 5A to 5C (the outer side surfaces 9y and the holes 9e in the side in the direction L are not illustrated). On the outer side surfaces 1y of the tubular portions 1c in the leftward and rightward directions L and R, supporting shafts 1e are provided integrally therewith as illustrated in FIG. 1, FIG. 3 and FIG. 5A to 5C (the outer side surfaces 1y and the supporting shafts 1e in the side in the direction L are not illustrated). By fitting the manipulation knobs 9 onto the tubular portions 1c from thereabove (from the side in the direction U) and, then, fitting the respective supporting shafts 1e on the tubular portion 1c to the respective holes 9e in the manipulation knobs 9, the manipulation knobs 9 are mounted to the tubular portions 1c. At the state where each manipulation knob 9 is mounted to the tubular portion 1c, by pushing downwardly or pulling upwardly its front end portion 9d for swaying it through manipulation in the forward and rearward directions F and B as illustrated in FIGS. 5A to 6C, the manipulation knob 9 is operated to rotate about the supporting shaft 1e.

Inside of each manipulation knob 9, a manipulation bar 9a and a tubular portion 9c are provided integrally with each other, as illustrated in FIG. 2, FIG. 4 and FIGS. 6A to 6C. The manipulation bar 9a is protruded downwardly (in the direction D) from the main body of the manipulation knob 9. A concave portion 9b is provided in the lower end portion of the manipulation bar 9a. At the state where each manipulation knob 9 is mounted to the tubular portion 1c, the manipulation bar 9a extends to the inside of the casing 1 through the tubular portion 1c, as illustrated in FIG. 2 and FIGS. 6A to 6C. An actuator 5a of a slide type electric switch 5 is engaged with the concave portion 9b in the manipulation bar 9a, as illustrated in FIG. 2. If each manipulation knob 9 is operated to be rotated, the manipulation bar 9a transmits this rotating operation to the actuator 5a of the corresponding electric switch 5 for sliding the actuator 5a in the forward and rearward directions F and B for changing over the electric contact point, not illustrated, which is provided inside the electric switch 5 to an ON state or an OFF state, thereby opening or closing the four windows provided in the vehicle.

The tubular portion 9c in each manipulation knob 9 is downwardly protruded and is opened at its lower surface (its end surface in the side in the direction D). A coil spring 10 as an elastic member and a plunger 11 are inserted in the inside of the tubular portion 9c. Inside of each tubular portion 1c in the casing 1, a supporting table 1f is provided integrally therewith, such that it does not obstruct the penetration of the manipulation bar 9a. In the supporting table 1f, there is provided a V-shaped slot 1g. On the inclined surfaces of the slot 1g which are inclined in the forward and rearward directions F and B, there are provided steps 1h. At the state where each manipulation knob 9 is mounted to the tubular portion 1c, the plunger 11 is downwardly biased due to the elastic force generated by the coil spring 10, so that the plunger 11 is engaged at its tip end with the slot 1g.

Before a manipulation knob 9 is swayed through manipulation, the plunger 11 is pressed against the deepest bottom of the slot 1g as illustrated in FIG. 6A due to the elastic force of the coil spring 10, so that the manipulation knob 9 stably rests with the attitude illustrated in FIGS. 5A and 6A. If a manipulation knob 9 is swayed through manipulation so that it is operated to be rotated as illustrated in FIGS. 5B, 5C, 6B and 6C, the plunger 11 is moved along an inclined surface of the slot 1g and then is moved beyond a step 1h, thereby generating a feeling of click. Then, if the manipulation for swaying the manipulation knob 9 is released, the plunger 11 is pushed and returned to the deepest bottom of the slot 1g as illustrated in FIG. 6A due to the elastic force of the coil spring 10, thereby restoring, to the rest position, the manipulation knob 9 which has been operated to be rotated, as illustrated in FIGS. 5A and 6A.

As stoppers for restricting the operation for rotating the respective manipulation knobs 9 to predetermined angles, each manipulation knob 9 and each tubular portion 1c are provided with first impingement portions 9j and 9k and first to-be-impinged portions 1j and 1k which impinge on each other, if the manipulation knob 9 is operated to rotate to reach the limits of the operation, as illustrated in FIGS. 6A to 6C. The impingement portions 9j are constituted by inclined surfaces at the lower ends of protrusions 9i provided integrally with the inner side surfaces 9x of the manipulation knob 9 in the leftward and rightward directions L and R anteriorly to the manipulation bar 9a (in the direction F) (in the FIGS. 6A to 6C, the inner side surface 9x, the protrusion 9i and the impingement portion 9j in the side in the direction L are illustrated, but these portions in the side in the direction R are not illustrated). The impingement portions 9k are constituted by inclined surfaces provided at the lower end portion of the inner side surface 9z of the manipulation knob 9 at its rear side (the side in the direction B). That is, the first impingement portions 9j and 9k are portions of each manipulation knob 9. The to-be-impinged portions 1j are constituted by horizontal upper surfaces at the front portion of the tubular portion 1c (portions of the upper surface 1x of the tubular portion 1c). The to-be-impinged portions 1k are constituted by inclined surfaces at the upper ends of protrusions 1i provided integrally with the outer side surface 1z of the tubular portion 1c at its rear side. That is, the first to-be-impinged portions 1j and 1k are portions of each tubular portion 1c.

Further, for buffering against the impingement between the respective manipulation knobs 9 and the respective tubular portions 1c, each manipulation knob 9 and each tubular portion 1c are provided with second impingement portions 9m and 9n and second to-be-impinged portions 1m and 1n which impinge on each other if the manipulation knob 9 is operated to be rotated as illustrated in FIGS. 5A to 5c. The second impingement portions 9m and 9n are constituted by the front side surfaces and the rear side surfaces of cutouts 9o provided in the lower end portions of the outer side surfaces 9y of the manipulation knob 9 in the leftward and rightward directions L and R (in FIGS. 5A to 5C, the outer side surface 9y, the cutout 9o and the impingement portions 9m and 9n in the side in the direction R are illustrated, but these portions in the side in the direction L are not illustrated). That is, the second impingement portions 9m and 9n are provided in the surfaces 9y of the manipulation knob 9 which are different from the surfaces 9x and 9z provided with the first impingement portions 9j and 9k and, therefore, the second impingement portions 9m and 9n form portions of the manipulation knob 9 which are different from the first impingement portions 9j and 9k. The second to-be-impinged portions 1m and 1n are constituted by the front side surfaces and the rear side surfaces of protrusions 1o which are provided integrally with the root portions of the outer side surfaces 1y of the tubular portion 1c in the leftward and rightward directions L and R, such that they are protruded outwardly (in FIGS. 5A to 5C, the outer side surface 1y, the protrusion 1o and the to-be-impinged portions 1m and 1n in the side in the direction R are illustrated, but these portions in the side in the direction L are not illustrated). That is, the second to-be-impinged portions 1m and 1n are provided on the surfaces 1y of the tubular portion 1c which are different from the surfaces 1x and 1z provided with the first to-be-impinged portions 1j and 1k and, therefore, the second to-be-impinged portions 1m and 1n form portions of the tubular portion 1c which are different from the first to-be-impinged portions 1j and 1k. The protrusions 1o and the second to-be-impinged portions 1m and 1n have elasticity since they are protruded from the tubular portion 1c by large amounts and, therefore, the protrusions 1o and the second to-be-impinged portions 1m and 1n are distorted more largely due to impingement than the second impingement portions 9m and 9n. The second impingement portions 9m and 9n and the second to-be-impinged portions 1m and 1n impinge on (contact with) each other over smaller areas than the areas over which the first impingement portions 9j and 9k and the first to-be-impinged portions 1j and 1k impinge on each other.

If the front end portion 9d of a manipulation knob 9 is raised by a finger so that the manipulation knob 9 is operated to be rotated, this will cause the second impingement portions 9n in the manipulation knob 9 and the second to-be-impinged portions 1n in the tubular portion 1c to impinge on each other, at first, as illustrated in FIG. 5B, which will cause the protrusions 1o and the second to-be-impinged portions 1n to be slightly deflected in the forward direction, thereby alleviating the impact between the manipulation knob 9 and the tubular portion 1c. Subsequently, as illustrated in FIG. 6B, the first impingement portions 9k in the manipulation knob 9 and the first to-be-impinged portions 1k in the tubular portion 1c are impinged on each other, thereby stopping the operation for rotating the manipulation knob 9.

If the front end portion 9d of a manipulation knob 9 is pushed downwardly by a finger so that the manipulation knob 9 is operated to be rotated, this will cause the second impingement portions 9m in the manipulation knob 9 and the second to-be-impinged portions 1m in the tubular portion 1c to impinge on each other, at first, as illustrated in FIG. 5C, which will cause the protrusions 1o and the second to-be-impinged portions 1m to be slightly deflected in the rearward direction, thereby alleviating the impact between the manipulation knob 9 and the tubular portion 1c. Subsequently, as illustrated in FIG. 6C, the first impingement portions 9j in the manipulation knob 9 and the first to-be-impinged portions 1j in the tubular portion 1c are impinged on each other, thereby stopping the operation for rotating the manipulation knob 9.

As described above, the manipulation knobs 9 and the tubular portions 1c for supporting them are provided with the second impingement portions 9m and 9n and the second to-be-impinged portions 1m and 1n, in addition to the first impingement portions 9j and 9k and the first to-be-impingement portions 1j and 1k, which enables absorbing the impact of the impingement between the manipulation knobs 9 and the tubular portions 1c while dispersing the impact to the impingement portions 9j, 9k, 9m and 9n and the to-be-impinged portions 1j, 1k, 1m and 1n, without concentrating it to a single position, if the manipulation knobs 9 are swayed through manipulation. This enables reducing the sound of the impingement which occurs at the time when the manipulation knobs 9 are swayed through manipulation.

Further, the second impingement portions 9m and 9n and the second to-be-impinged portions 1m and 1n are provided in the surfaces 9y and 1y in the manipulation knobs 9 and the tubular portions 1c which are different from the surfaces 9x, 9z, 1x and 1z provided with the first impingement portions 9j and 9k and the first to-be-impinged portions 1j and 1k in the manipulation knob 9 and the tubular portion 1c, which can reduce the amounts of distortions in the respective surfaces 9x to 9z and 1x to 1z in the manipulation knobs 9 and the tubular portions 1c which are provided with the impingement portions 9j, 9k, 9m and 9n and the to-be-impinged portions 1j, 1k, 1m and 1n, at the time when the manipulation knobs 9 are swayed through manipulation and, thus, the first and second impingement portions 9j, 9k, 9m and 9n impinge on the to-be-impinged portions 1i, 1k, 1m and 1n. This can reduce the echoes of sounds of impingements in the manipulation knobs 9, the tubular portions 1c and the casing 1 due to the distortions in the respective surfaces 9x to 9z and 1x to 1z.

Further, when the manipulation knobs 9 are swayed through manipulation, the second impingement portions 9m and 9n impinge on the second to-be-impinged portions 1m and 1n before the impingement between the first impingement portions 9j and 9k and the first to-be-impinged portions 1j and 1k. Accordingly, after the second impingement portions 9m and 9n impinge on the second to-be-impinged portions 1m and 1n to absorb the impact, the first impingement portions 9j and 9k impinge on the first to-be-impinged portions 1j and 1k to absorb the impact. Accordingly, the timing of the impingement between the second impingement portions 9m and 9n and the second to-be-impinged portions 1m and 1n is deviated from the timing of the impingement between the first impingement portions 9j and 9k and the first to-be-impinged portions 1j and 1k, thereby further reducing the sound of impingement.

Further, the second impingement portions 9m and 9n and the second to-be-impinged portions 1m and 1n are provided in the lower end portions of the outer side surfaces 9y of the manipulation knobs 9 in the leftward and rightward directions L and R and in the root portions of the outer side surfaces 1y of the tubular portions 1c in the leftward and rightward directions L and R. This can prevent the tubular portions 1c from being distorted at the time when the manipulation knobs 9 are swayed through manipulation and, thus, the second impingement portions 9m and 9n impinge on the second to-be-impinged portions 1m and 1n. This can prevent the resonance of the casing 1 due to the distortion of the tubular portions 1c, which can further reduce the sound of the impingement between the manipulation knobs 9 and the tubular portions 1c.

Further, the second impingement portions 9m and 9n and the second to-be-impinged portions 1m and 1n impinge on each other over smaller areas than the areas over which the first impingement portions 9j and 9k and the first to-be-impinged portions 1j and 1k impinge on each other. This can make the sound of the impingement between the second impingement portions 9m and 9n and the second to-be-impinged portions 1m and 1n to be smaller than the sound of the impingement between the first impingement portions 9j and 9k and the first to-be-impinged portions 1j and 1k at the time when the manipulation knobs 9 are swayed through manipulation, thereby reducing the overall sound of the impingement.

Further, at least ones 1m and 1n, out of the second impingement portions 9m and 9n and the second to-be-impinged portions 1m and 1n, have elasticity and, therefore, induce larger amounts of distortions therein due to impingement than the other ones 9m and 9n. Accordingly, when the manipulation knobs 9 are swayed through manipulation to cause the impingement between the second impingement portions 9m and 9n and the second to-be-impinged portions 1m and 1n, the to-be-impinged portions 1m and 1n are distorted to alleviate the impact, thereby preventing the occurrence of a sound of impingement.

Further, at least ones 1m and 1n, out of the second impingement portions 9m and 9n and the second to-be-impinged portions 1m and 1n, are constituted by the side surfaces, in the forward and rearward directions F and B, of the protrusions 1o protruded outwardly from the tubular portions 1c. Accordingly, when the manipulation knobs 9 are swayed through manipulation to cause the impingement between the second impingement portions 9m and 9n and the second to-be-impinged portions 1m and 1n, it is possible to prevent the generated sound of the impingement from being increased due to echoes of the generated sound of the impingement inside the manipulation knobs 9, the tubular portions 1c and the casing 1.

Further, the switch devices in the aforementioned Japanese Unexamined Utility Model Publication No. 05-36721 and Japanese Unexamined Utility Model Publication No. 02-87339 are structured, in order to reduce the sound of impingement during operations, to include an additional buffer member other than the manipulation knob and the member for supporting it (the tubular-shaped protruding portion and the sliding member in Japanese Unexamined Utility Model Publication No. 05-36721, and the cover, the terminal plate and the like in Japanese Unexamined Utility Model Publication No. 02-87339), which increases the cost. Particularly, if the operation handle and the cover are provided with a flexible portion or a flat spring made of a different material through co-molding as in Japanese Unexamined Utility Model Publication No. 02-87339, this will increase the fabrication cost.

On the contrary, in the present embodiment, the manipulation knobs 9 and the tubular portions 1c are provided with the first and second impingement portions 9j, 9k, 9m and 9n and the first and second to-be-impinged portions 1j, 1k, 1m and 1n, through common injection molding which involves relatively lower costs, not through co-molding which involves relatively higher costs, without adding buffer members other than the casing 1 including the manipulation knobs 9 and the tubular portions 1c for supporting them. This can reduce the sound of impingement which occurs when the manipulation knobs 9 are swayed through manipulation, while suppressing the increase of the cost of the switch device 100, with the existing number of components.

The present invention can be conducted in various types of embodiments other than the aforementioned embodiments. For example, while, in the aforementioned embodiment, there has been exemplified a case where, out of the second impingement portions 9m and 9n and the second to-be-impinged portions 1m and 1n, the impingement portions 9m and 9n are constituted by the side surfaces, in the forward and rearward directions F and B, of the cutouts 9o provided in the outer side surfaces 9y of the manipulation knobs 9 in the leftward and rightward directions L and R, and the to-be-impinged portions 1m and 1n are constituted by the side surfaces, in the forward and rearward directions F and B, of the protrusions 1o provided to be protruded outwardly from the root portions of the outer side surfaces 1y of the tubular portions 1c in the leftward and rightward directions L and R, such that only the to-be-impinged portions 1m and 1n have elasticity for inducing large amounts of distortions therein due to impingement, the present invention is not limited thereto.

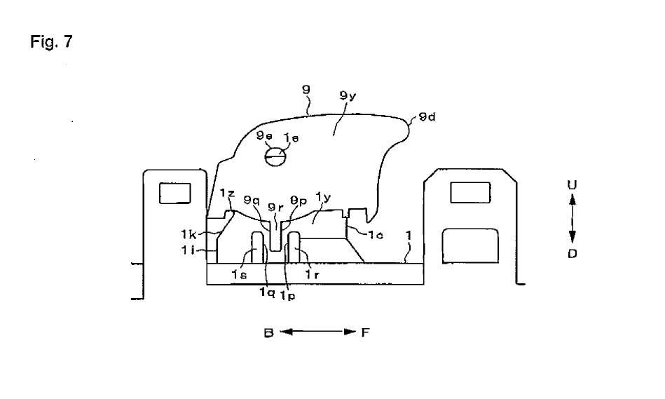

Instead of the aforementioned structure, as illustrated in FIG. 7, for example, second impingement portions can be constituted by the side surfaces 9p and 9q, in the forward and rearward directions F and B, of protrusions 9r provided integrally with the lower end portions of the outer side surfaces 9y of the manipulation knobs 9 in the leftward and rightward directions (in the direction perpendicular to the directions F and B and to the directions U and D) such that they are protruded outwardly therefrom, while second to-be-impinged portions can be constituted by the opposing side surfaces 1p and 1q of two protrusions 1r and 1s provided integrally with the root portions of the outer side surfaces 1y of the tubular portions 1c in the leftward and rightward directions such that they are protruded outwardly. Further, at least ones, out of the protrusions 9r and the impingement portions 9p and 9q in the manipulation knobs 9 and the protrusions 1r and 1s and the to-be-impinged portions 1p and 1q in the tubular portions 1c can be provided with elasticity for inducing large amounts of distortions therein due to impingement.

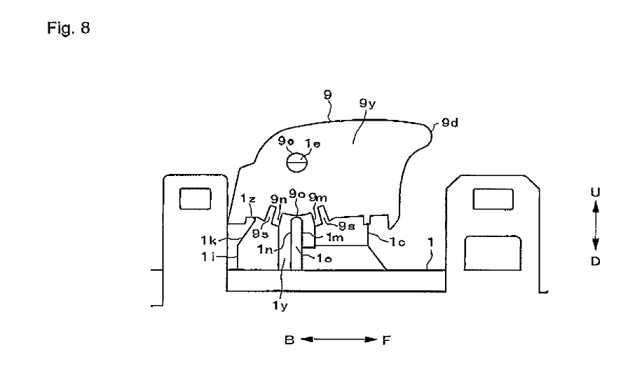

Also, as illustrated in FIG. 8, for example, slits 9s can be provided anteriorly F and posteriorly B to the cutouts 9o in the outer side surfaces 9y of the manipulation knobs 9 in the leftward and rightward directions (in the direction perpendicular to the directions F and B and to the directions U and D), in order to cause the impingement portions 9m and 9n in the manipulation knobs 9 as well as the impingement portions 1m and 1n in the tubular portions 1c to have elasticity for inducing larger amounts of distortions therein due to impingement.

While, in the aforementioned embodiment, there has been exemplified a case where, when the manipulation knobs 9 are swayed through manipulation, the second impingement portions 9m and 9n impinge on the second to-be-impinged portions 1m and 1n before the impingement between the first impingement portions 9j and 9k and the first to-be-impinged portions 1j and 1k, the present invention is not limited thereto, and the second impingement portions 9m and 9n and the second to-be-impinged portions 1m and 1n can be adapted to impinge on each other after the impingement between the first impingement portions 9j and 9k and the first to-be-impinged portions 1j and 1k.

Further, in the aforementioned embodiment, there has been exemplified a case where the present invention is applied to manipulation knobs for opening and closing windows and members for supporting the manipulation knobs in a switch device used in a power window device, the present invention can be applied to door-locking manipulation knobs and members for supporting these manipulation knobs. Also, the present invention can be applied to manipulation knobs and members for supporting these manipulation knobs in a switch device used in a door opening/closing device or the like. Also, the present invention can be applied to manipulation knobs and members for supporting these manipulation knobs in a switch device used in other applications than vehicles.

What is claimed is:

1. A switch device comprising:
a tubular portion which is provided in a casing and is opened at its upper and lower surfaces;
a supporting shaft provided in the tubular portion;
a manipulation knob which is mounted to the tubular portion such that it covers the opening in the upper surface and is operated to be rotated about the supporting shaft by being manipulated;
a switch provided in the casing;
a manipulation bar for transmitting the rotating operation on the manipulation knob for changing over the switch between an ON state and an OFF state;
an elastic member which generates an elastic force for restoring, to a predetermined rest position, the manipulation knob which has been operated to be rotated; and
a first impingement portion and a first to-be-impinged portion which are provided in the manipulation knob and in the tubular portion and are impinged on each other if the manipulation knob is operated to be rotated to reach a limit of this operation;
wherein a second impingement portion and a second to-be-impinged portion are provided in surfaces of the manipulation knob and the tubular portion which are different from the surfaces provided with the first impingement portion and the first to-be-impinged portion.

2. The switch device according to claim 1, wherein
the second impingement portion and the second to-be-impinged portion impinge on each other before or after the impingement between the first impingement portion and the first to-be-impinged portion when the manipulation knob is operated to be rotated.

3. The switch device according to claim 1, wherein
the second impingement portion and the second to-be-impinged portion are provided in the lower end portion of the manipulation knob and in the root portion of the outer side surface of the tubular portion.

4. The switch device according to claim 1, wherein
the second impingement portion and the second to-be-impinged portion impinge on each other over a smaller area than the area over which the first impingement portion and the first to-be-impinged portion impinge on each other.

5. The switch device according to claim 1, wherein
one of the second impingement portion and the second to-be-impinged portion causes a larger amount of distortion therein due to impingement than the other one.

6. The switch device according to claim 1, wherein
at least one of the second impingement portion and the second to-be-impinged portion is constituted by a side surface of a protrusion protruded outwardly from the manipulation knob or the tubular portion.
